(19) United States
(12) Patent Application Publication
(10) Pub. No.: US 2012/0173324 A1
(43) Pub. Date: Jul. 5, 2012

(54) Dynamic Product/Service Recommendations

(75) Inventors: Christina Marie Vallery, Austin, TX (US); William Leddy, Georgetown, TX (US)

(73) Assignee: eBay, Inc., San Jose, CA (US)

(21) Appl. No.: 13/326,548

(22) Filed: Dec. 15, 2011

Related U.S. Application Data
(60) Provisional application No. 61/428,157, filed on Dec. 29, 2010.

(51) Int. Cl. G06Q 30/02

(52) U.S. Cl. 705/14.25; 705/26.7

(57) ABSTRACT

Systems and methods according to one or more embodiments facilitate electronic commerce over a network. In an embodiment, a method comprises creating a user profile comprising information including data entered by a primary user related to a product or service on a user device as well as data from other users that are related to or have common interests with the primary user, wherein the user profile dynamically changes based on, at least in part, new actions by the primary user as well as new actions by the other users. The method also comprises weighing the information in the user profile to determine targeted recommendations for the primary user. And the method further comprises providing the targeted recommendations to the primary user based on the user profile.

### RELATED APPLICATIONS

The present patent application claims priority to and the benefit of U.S. provisional patent application No. 61/428,157 filed on Dec. 29, 2010, the contents of which are incorporated herein by reference in their entirety.

### BACKGROUND

1. Technical Field

The present disclosure generally relates to facilitating electronic commerce over a network and, more particularly, to providing targeted recommendations to individual consumers and to delivering relevant notifications about desired products or services.

2. Related Art

Online shopping is becoming more and more prevalent. However, consumers may not always find the “right” product or service through searches. In cases were consumers do find the “right” product or service, there may be factors that do not result in a purchase such as the price being too high. Furthermore, consumers may not know of other opportunities for a purchase, for example, consumers may not know where to find a particular product or service, or that certain desirable products or services even exist. This may result in potentially lost sales for sellers and missed opportunities for consumers.

### SUMMARY

According to one or more embodiments of the present disclosure, systems and methods facilitate electronic commerce over a network. In an embodiment, a method comprises creating a user profile comprising information including data entered by a primary user related to a product or service on a user device as well as data from other users that are related to or have common interests with the primary user, wherein the user profile dynamically changes based on, at least in part, new actions by the primary user as well as new actions by the other users. The method also comprises weighing the information in the user profile to determine targeted recommendations for the primary user. And the method further comprises providing the targeted recommendations to the primary user based on the user profile.

In another embodiment of the present disclosure, a system comprises: a client device interacting with at least one or more processors over a network; and one or more memories adapted to store a plurality of machine-readable instructions which when executed by the one or more processors are adapted to cause the system to: load an application on the client device wherein a primary user of the client device is allowed to enter data related to a product or service using the client device; create a user profile comprising information including the data entered by the primary user as well as information from other users that are related to or have common interests with the primary user, wherein the user profile dynamically changes based on, at least in part, new actions by the primary user as well as new actions by the other users; weigh the information in the user profile to determine targeted recommendations for the primary user; and provide the targeted recommendations to the primary user based on the weighted information of the user profile.

In yet another embodiment of the present disclosure, a system comprises: a user device having an application downloaded therein that allows a primary user to enter information related to products or services; at least one storage device that stores a user profile comprising the information entered by the primary user, and community user information of other users, wherein the other users have an affinity with the primary user based on comparisons of distance or attribute preferences between the primary user and the other users; at least one processor that interacts with the user device and the at least one storage device, wherein the at least one processor executes a plurality of machine-readable instructions adapted to cause the system to: create the user profile comprising information including the information entered by the primary user as well as information from the other users based on their affinity with the primary user, wherein the user profile dynamically changes based on, at least in part, new actions by the primary user as well as new actions by the other users; weigh the information in the user profile to determine targeted recommendations for the primary user; and provide the targeted recommendations to the primary user based on the user profile.

These and other aspects of the present disclosure will be more readily apparent from the detailed description of the embodiments set forth below taken in conjunction with the accompanying drawings.

### BRIEF DESCRIPTION OF THE DRAWINGS

FIG. 1 is a block diagram illustrating a system for determining and making a recommendation to a user according to an embodiment of the present disclosure.

FIG. 1A is a set of Tables 1-8 showing information for determining and making a recommendation according to an embodiment of the present disclosure.

FIG. 1B shows a general block diagram of the system of FIG. 1 according to an embodiment of the present disclosure.

FIG. 2 shows a flow for making a recommendation to a user on a user device according to an embodiment of the present disclosure.

FIG. 3 shows a block diagram of a computer system suitable for implementing one or more embodiments of the present disclosure.

Like reference numerals are used to identify like elements illustrated in one or more of the figures, wherein showings therein are for purposes of illustrating embodiments of the present disclosure and not for purposes of limiting the same.

Embodiments of the disclosure and their advantages are best understood by referring to the detailed description that follows.

### DETAILED DESCRIPTION

According to one or more embodiments of the present disclosure, an application may be downloaded on a user's client device (also referred to as a “user device”). The application may deliver recommendations, offers, finds or deals directly to the client device and may provide easy access, for example, by a single click. The application may also allow the user to either make a purchase using a payment provider such as PayPal®, explore auctions such as eBay® auctions, and/or tell friends about the latest offers, finds or deals.

It should be noted that embodiments herein are described with respect to an application titled “Frugal Fashionista” generally applicable in the fashion industry. However, it should be understood that embodiments of the present disclosure may be applicable to build a toolset or architecture that may be used to create an application around any other industry, including for example, other merchandise, hobbies, interests, collectibles, electronics, jewelry, furniture, power tools, gardening, electronics, etc. Embodiments herein may also be suitable for services such as car washes, doctors, lawyers, beauty salons, etc.

In embodiments herein, systems and methods provide recommendations to users based on a user profile that is dynamically changing, and may be based, in part, on actions of other users that are related to or have common interests as the current user. In addition, recommendations, offers, finds, or deals may be sent to users on products or services specifically sought-after. For example, a user profile may include information such as user searches, user purchases, user-entered data, as well as purchases and searches from other users. The information may be weighted differently to obtain a final decision on whether to make a specific recommendation to a user. The user's profile may change continually with new actions by the user or by other users, which may be weighted depending on how closely aligned (e.g., preferences) another user is with the current user.

It should be noted that “product or service” may also be referred to as “item” herein. “User” may also be referred to as “consumer” or “buyer”, and “seller” may also be referred to as “merchant” herein. Furthermore, it should be noted that the term “recommendation” may refer to a recommendation of an item that may or may not be specifically requested or sought by the user.

Advantageously for both sellers and consumers, methods and systems according to one or more embodiments provide specific or targeted recommendations to an individual consumer or buyer that are not strictly based on what the consumer searches for or purchases, as well as deliver deals regarding specifically sought-after products or services.

According to one embodiment, a user may, while shopping, scan a product code, e.g., a Universal Product Code (UPC), via an application downloaded on the user's client device. For example, the user may find a perfect dress, but may not want to pay retail price. The user may scan or otherwise enter the product code of the desired dress using the client device, as well as define additional specifications such as size, color, etc. The application may then deliver the best deal available to the user at that time. The user may proceed to purchase the dress, for example, by using a payment provider such as PayPal®, or bid on an auction such as an eBay® auction. As such, the user does not pay full price for the dress, but rather gets the best deal available.

If there are no deals available at that time, the user may simply save the fashion or dress preferences (e.g., size, color, etc.) and the application may alert the user as soon as a deal or offer comes available for the desired price the user wants to pay.

Furthermore, if the user has found a deal he or she would like to share, or, for example, wants advice from a friend about what to wear to an event, the user may be allowed to post and receive messages to members of a fashion posse. The user may send a message directly to someone in his or her posse, or post to an associated website, for example, Facebook™, a blog, Twitter™, or the like. Messages back to the user may be directly delivered via the application downloaded in the user device.

In other embodiments, the application may deliver offers or deals, for example a deal of the day, which the user may buy, for example, with a single click using a PayPal® account. Also, the user may see what other users have found, online or locally, and may elect to receive specific coupons or promotions from specific favorite merchants.

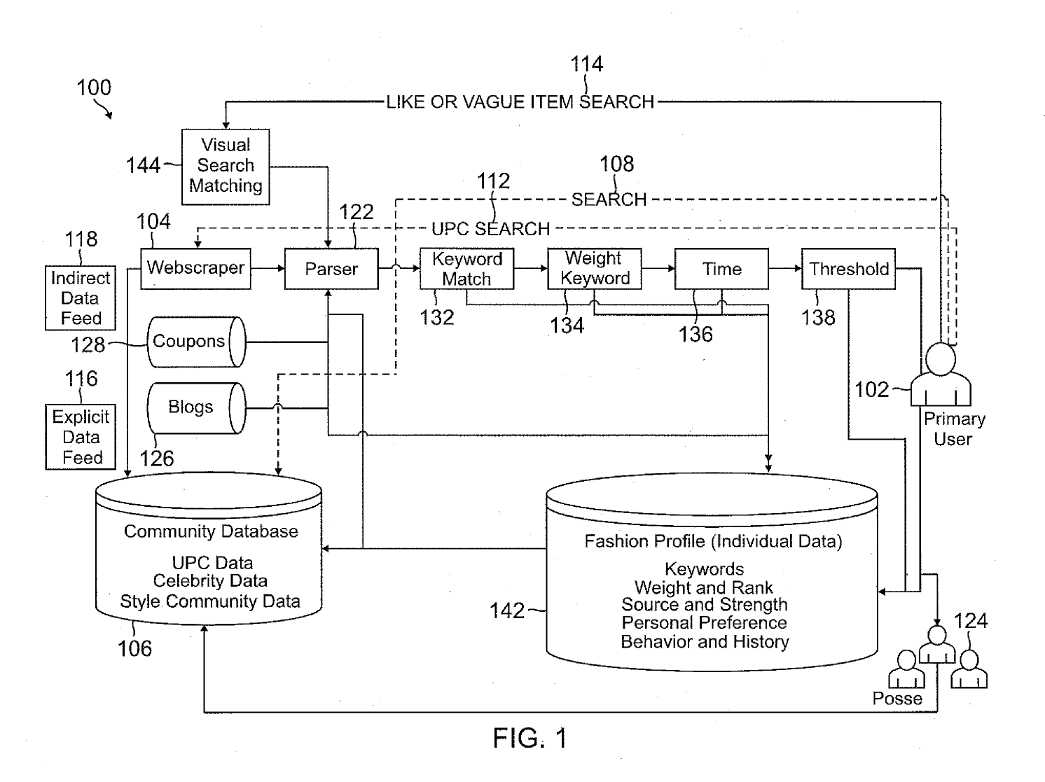

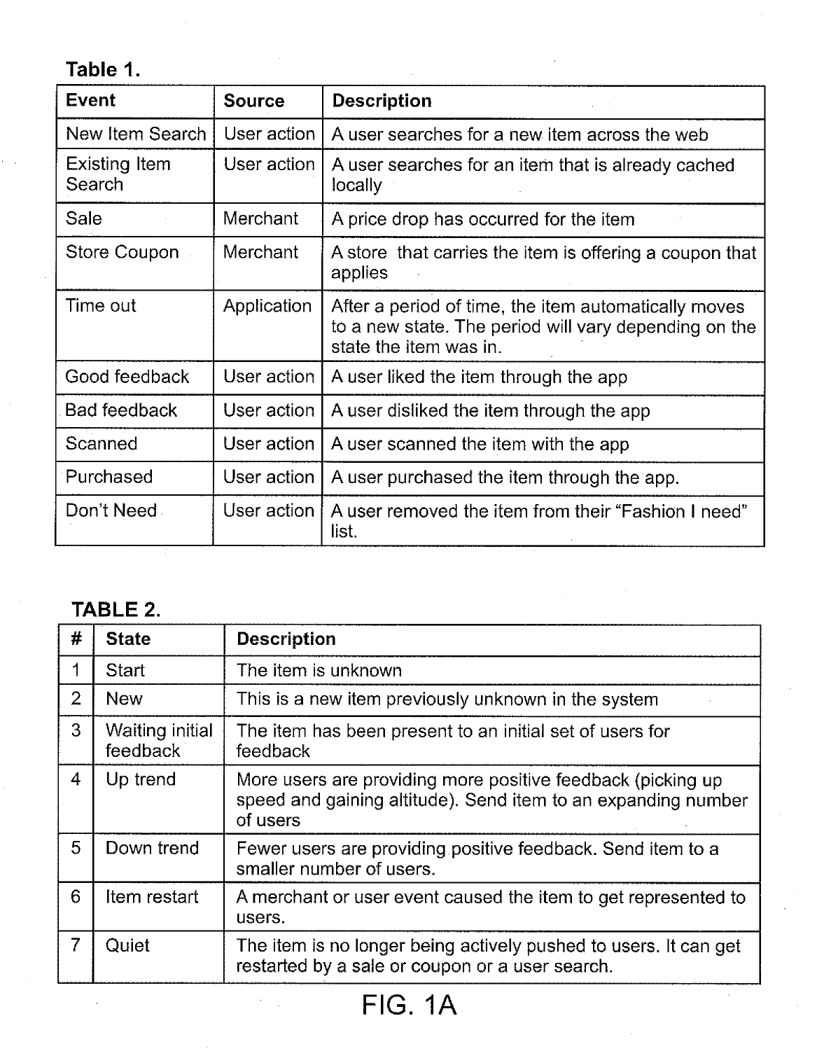

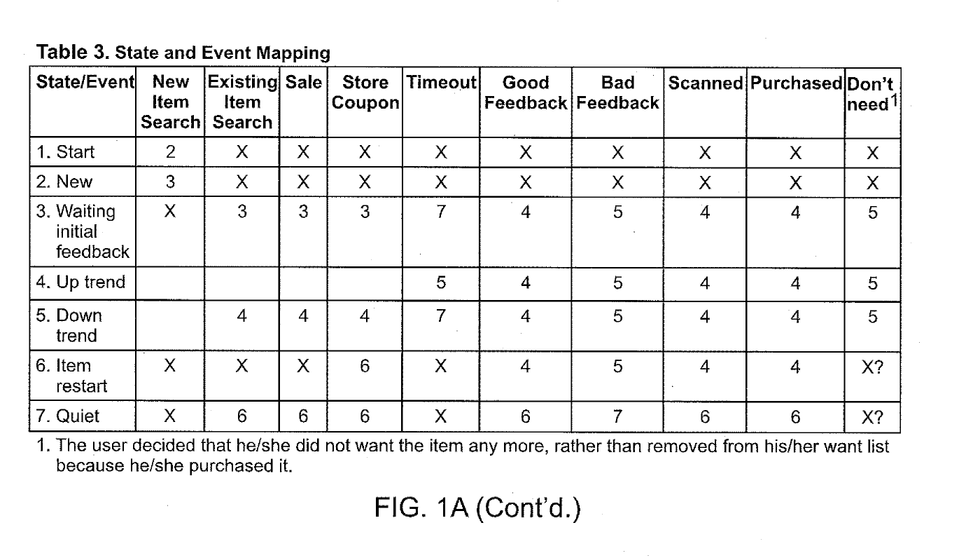

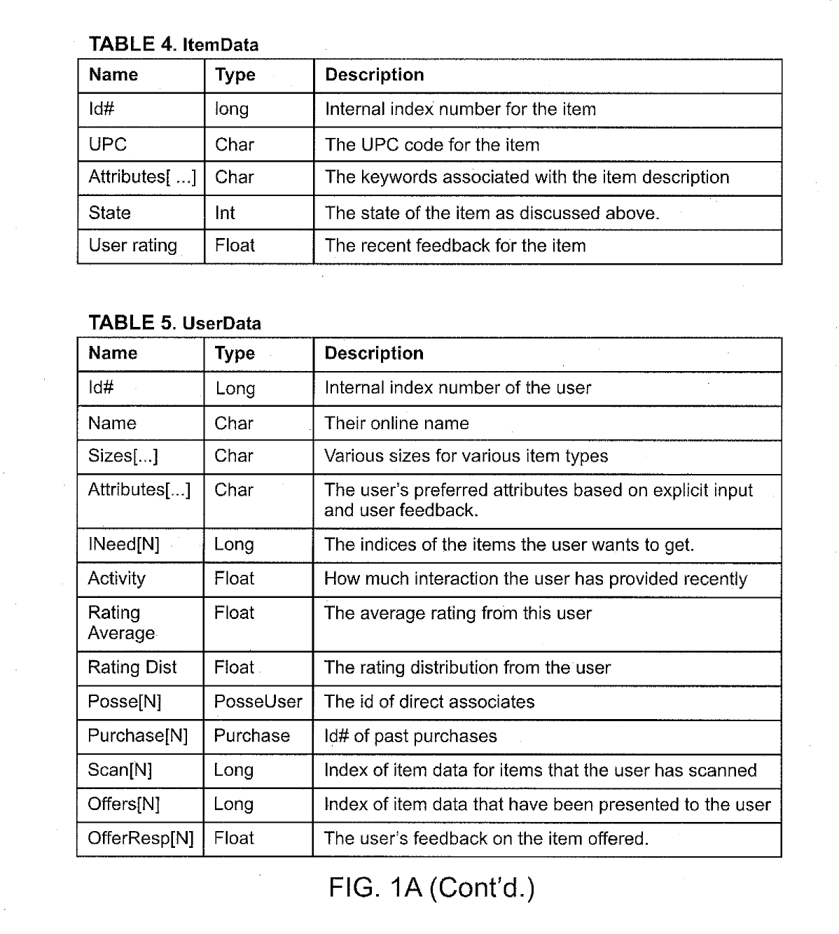

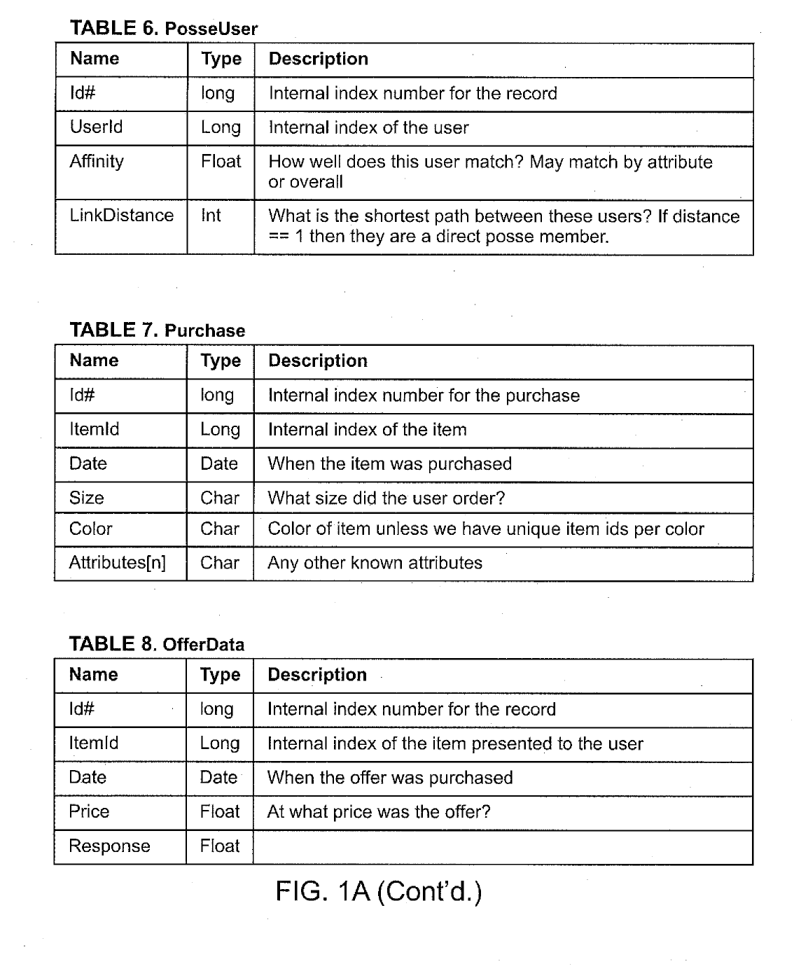

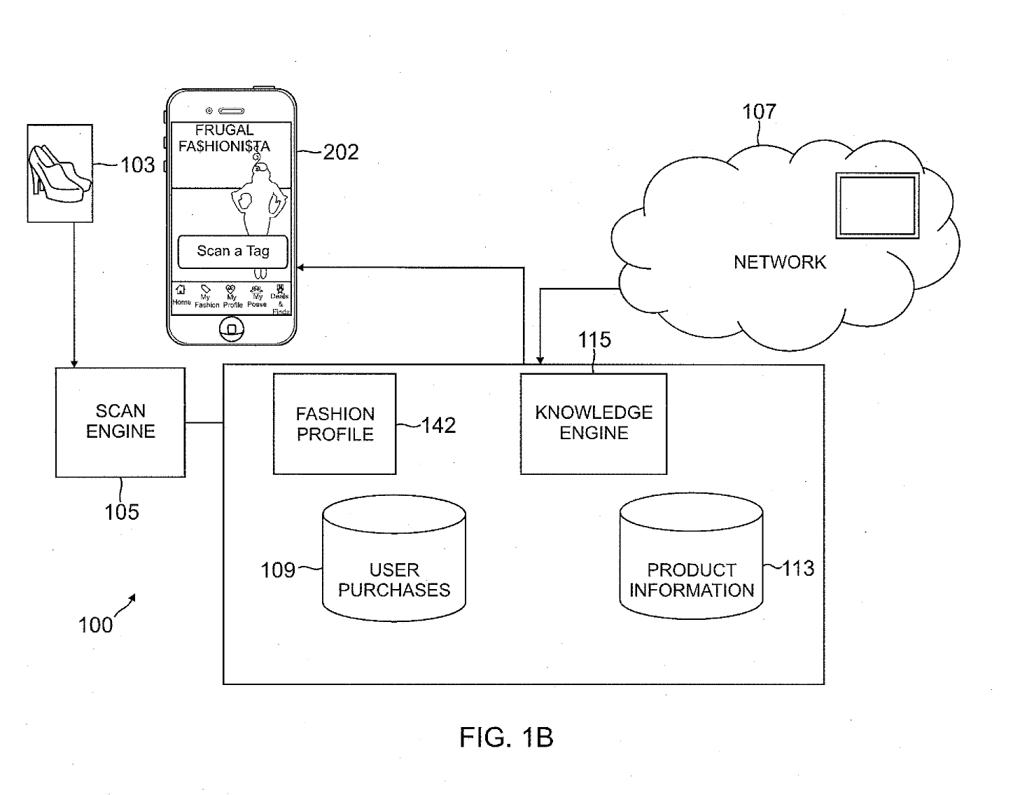

Referring to FIG. 1, a block diagram of a system for determining and making a recommendation for a product or service to a user is illustrated according to an embodiment of the present disclosure.

In the embodiment of FIG. 1, in addition to showing the layout of basic processing engines of a system 100 (also illustrated in the embodiment of FIG. 1B), FIG. 1 also shows the basic workflow from a primary user 102 through the processing engines of system 100 and the association between the processing engines, primary user 102, and data storage of both personal (individual user) information in a fashion profile 142 and community user information in a community database 106. FIG. 1B is a general block diagram of the system of FIG. 1 according to an embodiment of the present disclosure.

As noted above, one or more embodiments herein may be generally described in the context of products or services related to the fashion or clothing industry, however, embodiments of the present disclosure may also relate to any suitable recommendations or areas of interest, including, but not limited to, specific types of products or services, merchandise, hobbies, interests, collectibles, electronics, jewelry, furniture, power tools, gardening, electronics, etc. Service recommendations may also be suitable, such as car washes, doctors, lawyers, beauty salons, etc.

In the embodiment of FIG. 1, a system 100 may include several architectural components including a webscraper 104, a parser 122 that receives different data streams such as data from blogs 126, coupon offers 128, etc., a keyword matcher 132 and keyword manager 134, a timer component 136, a threshold component 138, as well as community database 106 and fashion profile or individual database 142.

There are at least three types of searches that a primary user 102 may launch from within an application downloaded on his or her client device (e.g., a mobile device) to search for desired products or services, which directly correspond to the user's intent:

1) User 102 may launch a standard search (as indicated by reference numeral 108). A standard search 108 may involve the user entering details into a traditional search form on his or her client device, which may or may not include product code information (manually entered and not scanned) as well as personal information such as size, color, designer preferences, etc.

2) User 102 may launch a product code search (as indicated by reference numeral 112), which may route to a webscraper 104. When there is no local data available and/or is used in combination with local data, webscraper 104 may retrieve information from associated APIs and/or directly from one or more websites to find relevant search results or data contributing to keywords. The data may be delivered directly to user 102 and/or stored as part of a community database 106.

A UPC or other product code search may be conducted using a scanning application, for example, a RedLaser® barcode scanning application from eBay® of San Jose, Calif. Data may be retrieved from the product code search and may be supplemented with user personal information such as size, color, designer preferences, etc.

3) User 102 may launch a Like or Vague Item search (as indicated by reference numeral 114). This type of search may be vague; user 102 may simply enter a description of the “type” of product or service he or she is looking for, as well as personal information such as size. This information may then be coupled with information from community database 106 as well as the user's individual data in fashion profile 142 to make recommendations that match the user criteria. In addition, if user 102 searches for a specific product or service using one of the aforementioned Search options, user 102 may also opt to receive like items. The like item search would be fulfilled by a Like or Vague Item Search, with the search criteria being derived from the parent search. This type of search may be performed in relation to a visual search matching 144, which may be an external engine or an internal engine such as an “eBay Like” search. In this regard, like items may be determined (i.e., quantification of the “like” or how closely the items are aligned) based on a score or strength of matches based on item attributes, user attributes, user past preferences, etc., where the score is then filtered against a threshold such that if the threshold is met, a recommendation may be made as will be described in more detail below.

There may be different types of data feeds, such as an indirect data feed 118 and an explicit data feed 116, that refer to the strength of data in contributing to the thresholds and the relevance score. Explicit data feed 116 may include data actually provided by the user, for example, based on what the user does (user may want a specific item like a red dress). As such, explicit data feed 116 has a high strength in contributing to the thresholds and the relevance score. Indirect data feed 118 may include data that is inferred by the user, for example, not based on what the user specifically does (e.g. based on “like” data) thus having less strength in contributing to the thresholds and the relevance score.

In other embodiments, there may also be a direct data feed and/or an indirect data feed from merchants. For example, a merchant may allow queries of its inventory, for example, excess inventory that the merchant may have available (instead of the merchant sending the inventory to an outlet mall). In an embodiment, a query to the merchant's API may be made to see if an item desired by the user is available, for example, if the user is looking for a red dress.

System 100, programmatically, may recognize the searches (e.g., 108, 112 or 114) as either an Explicit search or an Ongoing search relating to a network such as the Internet, or a Local search relating to a local database search.

In an Explicit search, web data may be searched for relevant products or services to be categorized. The web searches may be initiated explicitly by user 102 requesting a specific product or service, or something like a specific product or service. Data from the searches may be stored as part of the individual user's fashion profile 142 and may also be associated with the community database 106.

In an embodiment, matches may be made by the application (i.e., Frugal Fashionista) to expose relationships between like-minded individuals, and this information may be exposed to user 102 as part of a Fashion Twin functionality. A fashion twin may be another user that has a similar fashion sense or matching style as user 102. Once a twin association is made, recommendations may be shared or exposed between the connected individuals. For example, user 102 may want to know about purchases made by the fashion twin as they may indicate that a good deal was found. This, in effect, exposes a micro-community of like-minded individuals and that data may be stored as part of the community database 106.

In an Ongoing search, web searches may be automated and ongoing in an effort to find new interesting products or services for users and/or to find deal parameters that match those defined by the user. The prioritization of searched sites may be based on the cumulative user's interests in the results found on the sites and the type of products or services users prefer.

In a Local search, a local repository may provide a cache of search results that may be quickly queried for products or services, and similar products or services.

In addition to proactively searching for products or services, new products or services and changes to products or services may be identified from monitored data streams. These streams may include, for example: Blogs 126 that may provide the latest information on new products or services and trends; coupon offers 128 from sellers or merchants or manufacturers; sales, price changes and special offers; or results of searches from associated users (e.g. a Posse 124).

A parser 122 may be used to parse data from the multiple data streams such as blogs 126, coupon offers 128, and/or webscraper 104 and search results to identify products or services and extract relevant keywords. Each product or service may be added to the local repository and have a set of keywords or attributes associated with it.

Keyword Matcher 132 and Keyword Manager 134 may take the parsed keywords from parser 122 and apply them as attributes against a particular product or service. The semantics and context dependency may be derived by correlating the keyword with other descriptive attributes. Attributes may have aliases. For example, “full length” and “long” may have the same meaning in most contexts, or Ebony is equivalent to Black. Other attribute pairs may have a correlation, for example, Taupe and Beige, even if they are not direct aliases.

The product or service attributes are compared against the attributes from a user's fashion profile (which may be stored in fashion profile 142) to determine how closely the product or service matches the user's interest. The relative weighting of attributes is applied and the sum of the attributes is used to determine a score for a specific user.

If a user does not have an attribute in his or her profile, the initial value of the attribute may be derived by summing the attribute weighting from the user's associates (his or her Posse 124). Each associate in the sum may be weighted by the overall correlation between the two users across all attributes, as will be described in more detail below. This calculated value becomes the user's value for the attribute until the user has provided direct feedback on products or services with the attribute. A user's weight for a particular attribute may be determined in any number of ways, including behavior of the user and behaviors of the user's community. For example, purchases may be weighted more than searches. Products or services closer in price with the user's previous purchases may be weighted more than more expensive products or services. The closeness of a product or service to a preference, such as color, may be weighted accordingly.

After the product or service (item) is scored against a specific user by comparing the attributes, the score is compared with a threshold (indicated by reference number 138) to determine if the product or service should be presented to user 102 now or possibly later. If the score of the particular item meets a minimum threshold, the particular item may be presented to the user. The threshold for user 102 may vary over time based on, for example: 1) The number of items per day the user selected to see; 2) The number of items per day that the user actually reviews; 3) Time of day that the user is most interested in seeing items; 4) The number of items per period that are likely to match the user's preferences.

These factors plus the matching item arrival rate may determine if and when a specific item should be presented to the user. For example, an item that barely meets the minimum threshold match for the user may be deferred for several hours to see if better matches arrive.

Each product or service (item) may go through a lifecycle based on a time factor (as indicated by reference numeral 136). The lifecycle may be managed by a state machine described in more detail below, according to one or more embodiments, in connection with the Tables of FIG. 1A. Most states in the machine may have an associated timer that may expire if no additional events happen during the state. Upon expiration, the item status may transition to the next state defined in the state table. If a new event occurs the timer may be restarted in the current state. Ultimately, users may lose interest in an item and no new events may occur. The item may then enter a quiet state until a user searches for the item or a sale occurs to reactivate the item.

Each user may have a fashion profile 142 (also referred to as “individual database”) that contains the user-specific weighting for attributes. In many cases there may be direct evidence that a user likes a specific attribute (example: scanned multiple pairs of black shoes), but in other cases the evidence may be indirect (example: might like black dresses since user likes black shoes). Where a user does not have a weighting for an attribute, the average of the user's posse 124 may be applied instead.

For each item presented to user 102, if user 102 chooses to see more details (e.g., clicks through to see more details on an interface of the client device), user 102 may provide feedback on the item with a single click or other appropriate interface on the user's client device. This feedback may be recorded for the item and applied to the associated attributes. By analyzing this feedback, system 100 may determine the user's relative value per attribute. For example, after getting feedback on a sufficient number of shoes, it may be possible for system 100 to determine that a user did not like a pair of shoes because the shoes had peep toes rather than because they were pink. The user may be given the opportunity to revise or edit the profile.

In general, the user's fashion profile 142 may include data or information such as keywords, weight and rank, source and strength, personal preferences, behavior and history with respect to, for example, eBay® and PayPal®, as well as any other appropriate data or information.

Community database 106 may house all of the information not related to fashion profile 142, and may be used in creating and/or updating the user's profile as well as determining items to recommend; it is ever evolving and may include full product inventory and knowledge; ratings, recommendations and preferences on inventory and how items have been received in the fashion community; critical data on user behavior and activity, and all keyword associations, including a data bank on celebrities and their related inventory.

Each user may be bi-directionally linked to a set of associates. This set is called the Posse (as indicated by reference numeral 124). Each user has his or her own distinct Posse. It is unlikely that any two Posse's memberships will be identical.

User 102 may feed items and receive the same in exchange. By purchasing an item, scanning an item, reading a blog, or saying that the user likes an item, the item may be directed to Posse 124, or used as a way to establish a relationship outside of the posse, in the larger community, for example, by identifying a style twin.

When user 102 does not yet have an opinion on an item attribute, the user's Posse 124 may provide a proxy opinion until user 102 provides more input on items with that attribute.

User 102 may directly link with friends to see what items they are buying, scanning, and reading about. These direct links are only one link distance from the user and may be visible from the user's profile. In addition to explicit links made by the user, system 100 may compare user's attribute preferences to find the correlation or affinity between two users. Users with the strongest affinity may be transparently linked to the user's profile. The link distance of the shortest path between two users will be calculated. The affinity between users may be used in weighting the value of each proxy member when deciding the value of attributes or estimating the user's interest in seeing a new item.

The affinity between a user and their Posse members may be recalculated when a user provides feedback on an additional “N” number of items. The Posse membership for members that are not explicitly linked may likely vary over time, fashion trends and seasons. In other embodiments, Posse members may be linked with the user through one or more other users, with weightings factored in accordingly based on how removed the relationship is. Other factors may also be used, such as level of interaction with a Posse member (e.g., friend on a social network, such as Facebook®, etc.), geographical closeness to the Posse member, etc.

When a user conducts a search through system 100 such as via an application loaded on a user's client device, there are four distinct types of output that may be supported:

1) Recommendation: A recommendation may involve an item that the user has not explicitly asked for, but that he or she has opted to receive; the recommendation may be derived through a process such as the sample process shown in the code sample below. In one embodiment, before a recommendation is made, the system may analyze recent user behavior, time of year, availability, strength of match, and other pertinent information as discussed above.

2) Standard Search Result: A standard search result is returned when a user has requested a specific item through a description. The user may receive one or more notifications/recommendations of one or more deals or offers targeted for that specific item.

3) Product Search Result: A product search results is returned when a user has requested a specific item through a product code scan, such as using the RedLaser® application from eBay®. The user may receive one or more notifications/recommendations of one or more deals or offers targeted for that specific item.

4) Like or Vague Item Search Result: A like or vague item search result is returned when a user has requested a type of item through a like or vague item search.

The following shows a sample code portion for determining a recommendation for a user.

Match an Item to a User, Calculate User Value, Relate to Posse Clones

```
// check how well an item matches a user
Float checkMatch(item, user)
{
Float result = 0;
For (i=0; I < item.attributeCount( ); i++)
{
Float tweight = user.getWeight(item.attribute[i].name);
        If (tweight > −1)
        {
            Result += tweight;
        }
    } // for
    Return result;
}
// Get the calculated user value for the user for a particular attribute
// If the user does not already have this attribute then calculate it from the
posse and use that
Float user::getWeight(attributeName)
{
    For (i=0; i < user.attributeCount( ); i++)
    {
        If (user.attribute[i].name == attributeName)
        {
                Return user.attribute[i].weight;
        }
    }
    // user had no matching attribute use the nearest fashion style clones
    Float posseSum;
    Int pCount = 0;
    For (i=0; i < user.posseCount( ) || i < MAXPOSSE; i++)
    {
        Float posseWeight = (1 − user.posse[i].affinity) *
user.posse[i].getWeight(attributeName);
        If (posseWeight >= 0)
                {
            posseSum += posseWeight;
            ++pCount;
        }
    }
    If (posseSum >= 0)
    {
        User.addAttribute(attributeName, posseAverage); // use the
clone's average as the users default so we don't need to recalculate
next time
        return posseSum/pCount; // return the average for users
        with opinions
    }
    If (posseAverage >= 0) return posseAverage;
    Else return −1;
}
```

Events

Every item should have an associated state. The item may be driven to new states by events. The events are described in Table 1 of FIG. 1A according to one or more embodiments of the present disclosure.

For example, an event, “New Item Search”, may involve a user searching for a new item across a network such as the web. Another event, “Existing Item Search”, may involve the user searching for an item that is already cached locally. Yet another event, “Sale”, may involve a merchant dropping the price of the item. There may be other events as listed in Table 1 according to one or more embodiments.

States

An item may be in one of different possible states as described in Table 2 of FIG. 1A according to one or more embodiments of the present disclosure.

For example, Table 2 lists seven possible states in which an item may be. A “Start” state indicates that the item is unknown. A “New” state indicates that the item is new or previously unknown in the system. A “Waiting initial feedback” indicates that the item has been presented to an initial set of users for feedback, and so on.

State and Event Mapping

Table 3 of FIG. 1A sets forth various possibilities for state and event mapping according to one or more embodiments of the present disclosure. Table 3 is a state transition table where the numbers refer to mapping representative of a path. In Table 3, the left column defines the states and the first row defines the events. Each state is numbered, e.g., 1-7. If an item is in a state (pick the row) and an event (pick the column) occurs, the number indicates the next state. For example, if the item is in a state 3 “Waiting initial feedback” and an event occurs, for example, a “Timeout,” the number 7 indicates the next state is “Quite”. It should be noted that the state table is extensible for both more states and more event types so that it may be expanded easily, minimizing code changes.

Item Data

Table 4 of FIG. 1A lists potential information related to an item, or Item Data, according to one or more embodiments of the present disclosure.

For example, item data may include a corresponding identification number (Id#) of a long type that is an internal index number for the item. Item data may also include a UPC code, certain attributes that may be the keywords associated with the item description, and/or the state the item is in, for example, as listed in Table 2 described above. Also, the item data may include a “User rating”, which may be the recent feedback for the item.

Table 5 of FIG. 1A lists potential information related to a user, or User Data, according to one or more embodiments of the present disclosure.

For example, user data may include a corresponding identification number (Id#) of a long type that is an internal index number for the user. User data may also include the user's online name, various sizes for various item types, the user's preferred attributes based on explicit input and user feedback, and/or other user data as listed in Table 5 according to one or more embodiments.

Table 6 of FIG. 1A lists potential information related to a user's posse, or PosseUser, according to one or more embodiments of the present disclosure.

For example, Posse user data may include a corresponding identification number (Id#) of a long type that is an internal index number for the record and/or a corresponding identification number (userId) that is an internal index of the user. Posse user data may also include “Affinity” information that corresponds to how well the posse user matches to the primary user, and also “LinkDistance” that indicates the shortest path between the posse user and the primary user. For example, the path may be indicated by an integer value. If integer values are used to represent the “LinkDistance” data, and the smallest integer represents the distance between connections, then 1 may be the value between the primary user and a posse user, i.e., if the distance is =1 then the posse user is a direct posse member.

Table 7 of FIG. 1A lists purchase data according to one or more embodiments of the present disclosure.

For example, purchase data may include an identification number of the long type (Id#) that corresponds to an internal index number for the purchase, an “itemId” that corresponds to an internal index of the items, a “Date” of when the item was purchased, the “Size” of an item the user ordered, the “Color” of an item the user ordered, and/or other applicable “Attributes” for the item.

Table 8 of FIG. 1A lists offer data according to one or more embodiments of the present disclosure. Offer data may refer to, for example, offers, coupons, discounts, promotions, or the like that are presented by a merchant in connection with one or more items.

For example, offer data may include an “Id#” that is an internal index number for the record, an “itemid” that is an internal index of the item presented to the user”, a “Date” when the offer was presented, a “Price” at which the offer was presented, and a potential “Response”.

Referring to FIG. 1B, a general block diagram of the system of FIG. 1 is shown according to an embodiment of the present disclosure.

In FIG. 1B, system 100 generally includes a client device 202 of a primary user 102 and various processing engines including a scan engine 105 and a knowledge engine 115. Other users may also contribute to knowledge engine 115 via a network 107, for example, the world wide web. Client device 202 may be adapted to interact with scan engine 105. For example, as described above according to one or more embodiments, user 102 may scan a product or service 103 (e.g. a pair of desired shoes) with user device 202 via scan engine 105. Product Information 113 pertaining to product or service 103 as obtained via scan engine 105 may be stored in a knowledge engine 115. A fashion profile 142 may be created for user 102 and may include, for example, information pertaining to actual user purchases 109.

The network 107, in one embodiment, may be implemented as a single network or a combination of multiple networks. For example, in various embodiments, the network 107 may include the Internet and/or one or more intranets, landline networks, wireless networks, and/or other appropriate types of communication networks. In another example, the network 107 may comprise a wireless telecommunications network (e.g., cellular phone network) adapted to communicate with other communication networks, such as the Internet. As such, in various embodiments, the user device 202, as well as other appropriate servers, for example seller servers and payment provider servers may be associated with a particular link (e.g., a link, such as a URL (Uniform Resource Locator) to an IP (Internet Protocol) address).

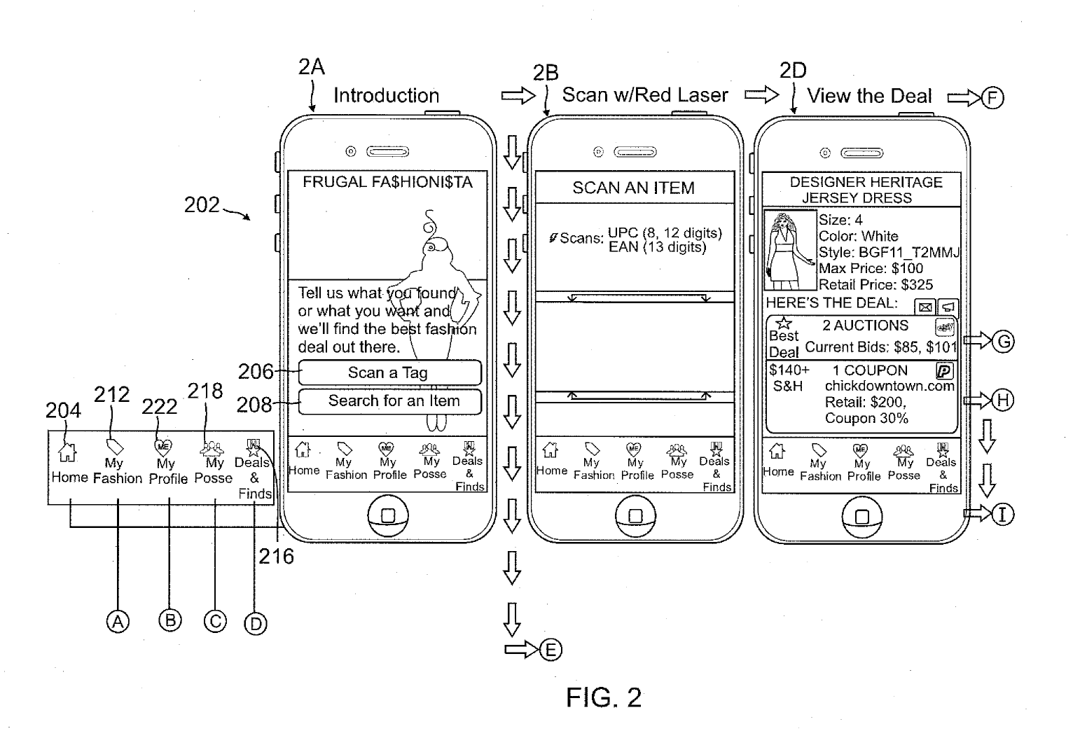

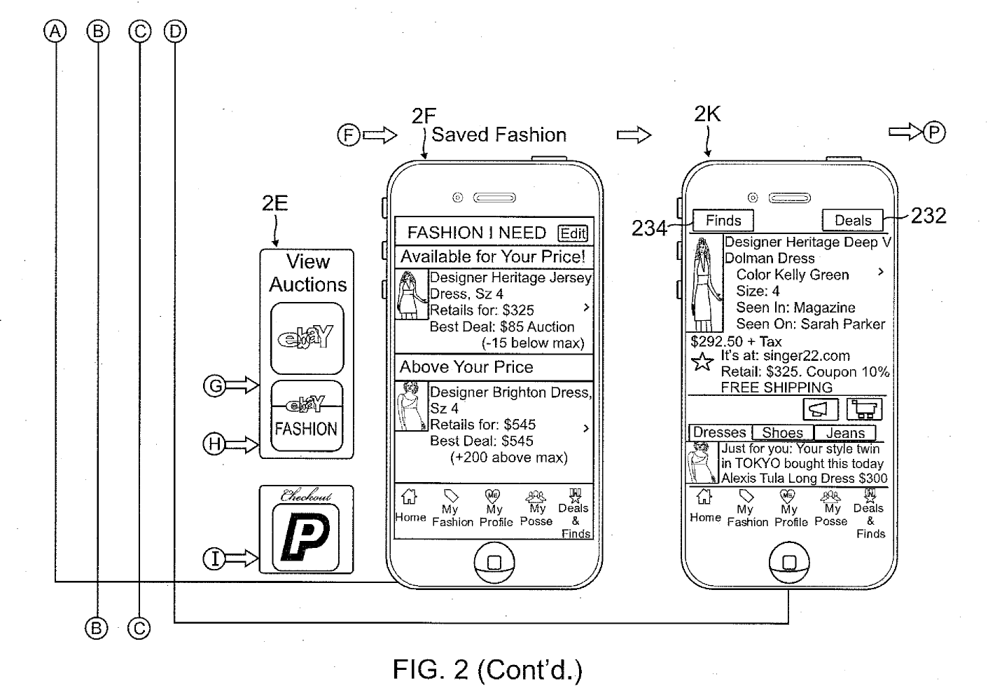

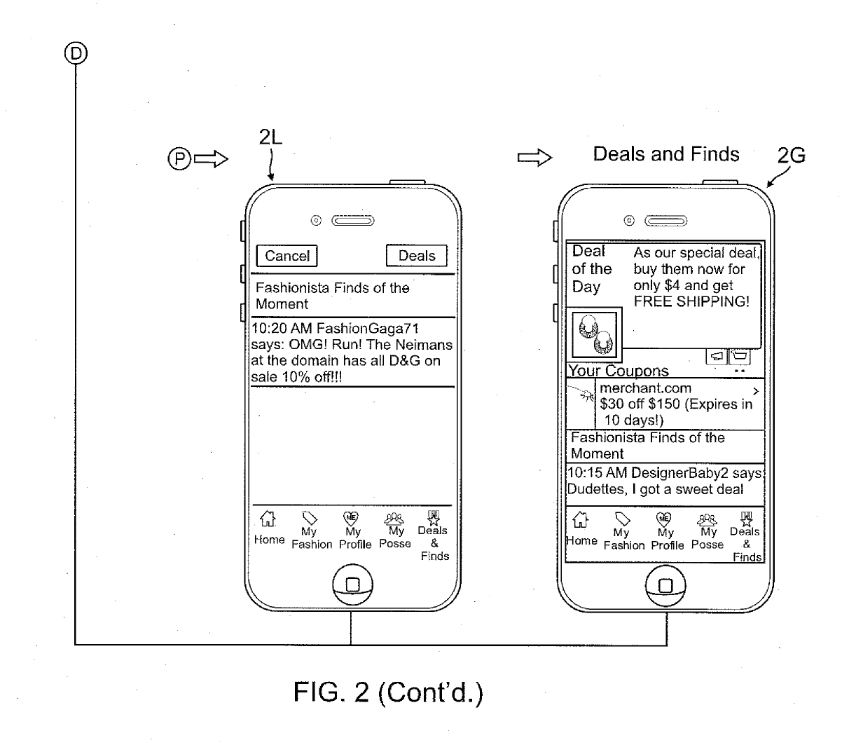

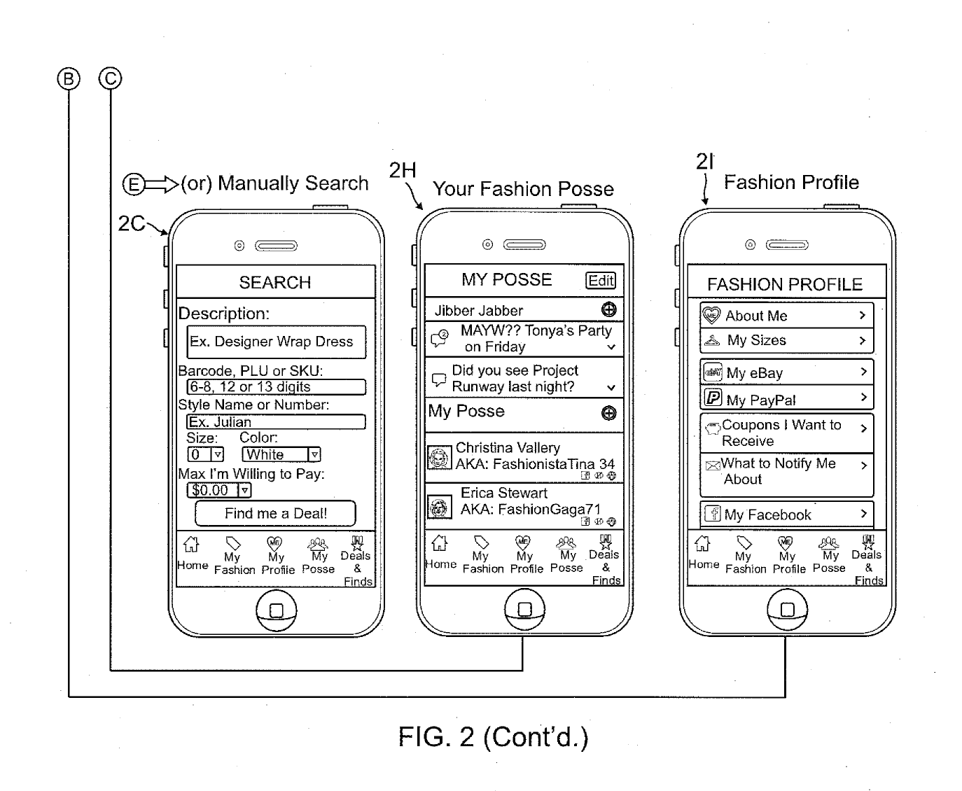

Referring now to FIG. 2, a flow illustrating the recommendation process using a client device is shown according to an embodiment of the present disclosure.

A client device 202 of a user (such as user 102 of the embodiment of FIG. 1) may include a downloaded application according to one or more embodiments of the present application. In the embodiment of FIG. 2, the application may be entitled “Frugal Fashionista”, but any other appropriate title may be used. The application may deliver fashion deals directly to client device 202. As stated above, it should be understood that fashion is an example of an application that may be built in this common infrastructure, however, other embodiments may be used for other market segments or industries.

If a user decides to purchase the delivered fashion deal at that time, a convenient single-click access, for example, may be provided using a service provider such as PayPal®. Also, the application may provide easy access, e.g., single-click access, to view and bid on existing auctions such as eBay® auctions. Furthermore, the application may allow users to chat with their friends and post to social media websites about their finds.

In the embodiment of FIG. 2, view 2A presents an introduction view to the user that corresponds to a “home” icon 204. In this introduction view 2A, the user may be given options to input information about an item that the user has found or that the user wants, so that the system may find the best fashion deal available. For example, the user may be given options including to “Scan a Tag” 206, “Search for an Item” 208, or any other options to input information about an item via appropriate interfaces in the user device according to one or more embodiments.

The user may choose to “Scan a Tag” 206, which causes the application to present a view 2B directing the user to scan a product code of an item. It should be noted that scanning may be done by any appropriate method including using a RedLaser® scanning application from eBay, Inc. Alternatively, the user may choose to “Search for an Item” 208, which causes the application to present a view 2C directing the user to manually search for an item by manually entering keywords or other information such as item Description, Barcode, PLU or SKU, Style Name or Number, Size, Color, Maximum Amount the user is willing to pay, or any other such appropriate information.

In an embodiment where the user chooses to scan an item, such as in view 2B, a view 2D is presented to the user, where a deal is presented to the user. For example, the user may have found a perfect dress, but does not want to pay retail price. The user may Scan the desired item (as in view 2B), and the application delivers the best deal available then, as presented in view 2D. The user may choose to buy the item right then using a payment provider such as PayPal®, or bid on an auction such as an eBay® auction as indicated in block 2E. As such, the user may not pay retail prices.

In cases where no deals are available at the time, the user may simply save the items as in view 2F, and the application may alert the user as soon as a deal comes available for the price the user wants to pay. Icon 212, which may have a label “My Fashion” or any other appropriate label, corresponds to view 2F illustrating the saved desired fashion items.

In one or more embodiments, the application may deliver recommendations targeted to the user, for example, as reflected in view 2K, which the user may buy with, for example, a single click using a PayPal® account. In this example, the user is presented with a recommended dress just for the user. Also, the user may be presented with a recommended dress that the user's style twin has bought.

The application may further deliver deal notifications, for example, a “Deal of the Day,” as reflected in view 2G, which may be accessed via an icon 232 labeled “Deals”, or any other appropriate label, on view 2K. The user may also see what other “fashionista” users have found, online or locally, and may elect to receive specific coupons and promotions from one or more favorite merchants as illustrated in view 2G.

The application may further deliver finds, for example “Fashionista Finds of the Moment” as reflected in view 2L, which may be accessed via an icon 234 labeled “Finds”, or any other appropriate label, on view 2K. The user may also buy deals or finds as reflected, for example, in views 2G and/or 2L with, for example, a single click using a PayPal® account. Icon 216, which may have a label “Deals and Finds” or any other appropriate label, corresponds to view 2K illustrating targeted recommendations, and also to view 2G illustrating the “Deal of the Day” and other coupons or promotions from favorite merchants, as well as to view 2L illustrating “Finds”.

In one or more embodiments, an icon 218 labeled “My Posse”, or any other appropriate label, may correspond to view 2H. When the user has found a recommendation, deal or find that he or she wants to share, or for example, wants advice from a friend about what to wear to a special event, the application allows the user to post and receive messages to his or her fashion posse. The user may send a message directly to someone in his or her posse, or post to an appropriate website, Facebook®, the user's Wordpress blog, Twitter®, or any other appropriate social media. Messages back to the user may be directly delivered to the “Frugal Fashionista” application.

In one or more embodiments, an icon 222 having a label “My Profile” or any other appropriate label, may correspond to view 2I illustrating the user's “Fashion Profile”. The user's fashion profile may include information about the user such as size, preferences, purchases, coupons the user would like to receive, etc.

Client device 202, in one embodiment, includes a user interface application, which may be utilized by the user 102 to conduct financial transactions (e.g., shopping, purchasing, bidding, etc.) with a service provider server such as PayPal® over a network. In one aspect, purchase expenses may be directly and/or automatically debited from an account related to the user 102 via the user interface application.

In one implementation, the user interface application comprises a software program, such as a graphical user interface (GUI), executable by a processor that is configured to interface and communicate with a payment provider server via a network. In another implementation, the user interface application comprises a browser module that provides a network interface to browse information available over the network. For example, the user interface application may be implemented, in part, as a web browser to view information available over the network. In another example, the user 102 is able to access seller or merchant websites via one or more merchant servers to view and select products and/or services for purchase, and the user 102 is able to purchase products and/or services from the one or more merchant servers via the payment provider server. Also, the user 102 may conduct financial transactions (e.g., purchase, set up and provide payment for products and/or services) via the payment provider server.

The client device 202, in various embodiments, may include other applications as may be desired in one or more embodiments of the present disclosure to provide additional features available to the user 102. In one example, such other applications may include security applications for implementing client-side security features, programmatic client applications for interfacing with appropriate application programming interfaces (APIs) over the network, and/or various other types of generally known programs and/or software applications. In still other examples, the other applications may interface with the user interface application for improved efficiency and convenience.

According to one or more embodiments, the user interface application or the other applications include a payment application that may be loaded on client device 202 by the payment provider server. Such payment application enables user 102 to easily set up a payment process or make payments for products and/or services over client device 202.

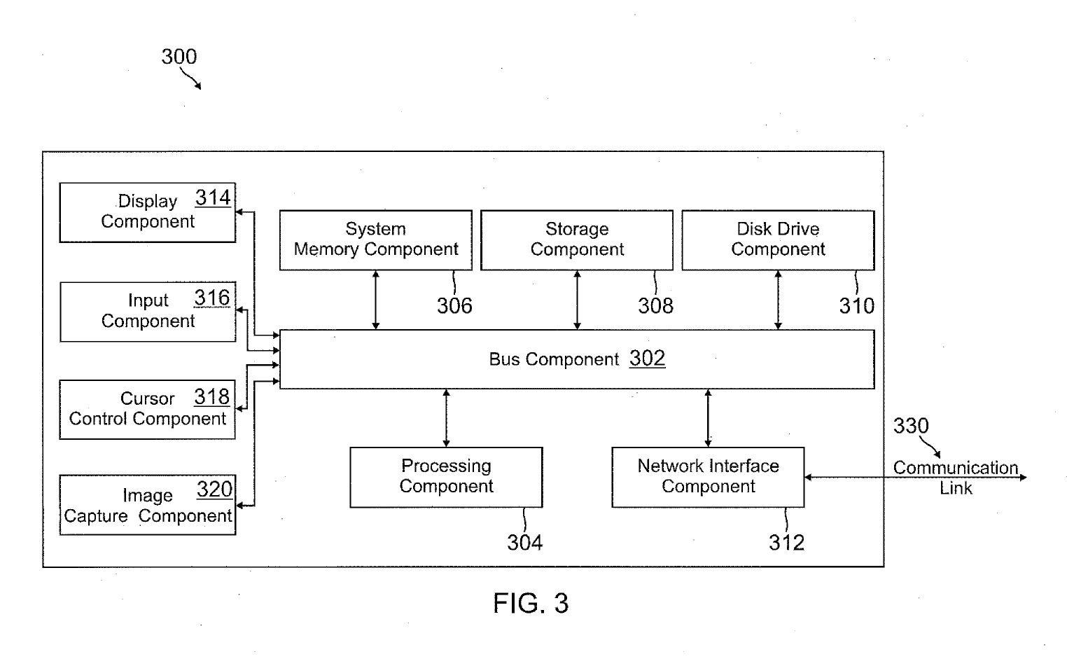

Referring now to FIG. 3, a block diagram of a computer system 300 suitable for implementing various devices described herein is illustrated according to an embodiment of the present disclosure. In various implementations, user or client devices may comprise a network communication device (e.g., mobile cellular phone, laptop, personal computer, etc.) capable of communicating with a network, and a payment provider device (such as managed by PayPal® or eBay® of San Jose, Calif.) may comprise a network computing device (e.g., a network server). In other implementations, it should be appreciated that the payment provider device may comprise a network communication device (e.g., mobile cellular phone, laptop, personal computer, etc.) capable of communicating with the network, without departing from the scope of the present disclosure. Accordingly, it should be appreciated that each of the devices may be implemented as the computer system 300 for communication with the network in a mariner as follows.

In accordance with various embodiments of the present disclosure, computer system 300, such as a mobile communication device and/or a network server, includes a bus 302 or other communication mechanism for communicating information, which interconnects subsystems and components, such as processing component 304 (e.g., processor, micro-controller, digital signal processor (DSP), etc.), system memory component 306 (e.g., RAM), static storage component 308 (e.g., ROM), disk drive component 310 (e.g., magnetic or optical), network interface component 312 (e.g., modem or Ethernet card), display component 314 (e.g., CRT or LCD), input component 316 (e.g., keyboard), cursor control component 318 (e.g., mouse or trackball), and image capture component 320 (e.g., analog or digital camera). In one implementation, disk drive component 310 may comprise a database having one or more disk drive components.

In accordance with embodiments of the present disclosure, computer system 300 performs specific operations by processor 304 executing one or more sequences of one or more instructions contained in system memory component 306. Such instructions may be read into system memory component 306 from another computer readable medium, such as static storage component 308 or disk drive component 310. In other embodiments, hard-wired circuitry may be used in place of or in combination with software instructions to implement the present disclosure.

Logic may be encoded in a computer readable medium, which may refer to any medium that participates in providing instructions to processor 304 for execution. Such a medium may take many forms, including but not limited to, non-volatile media and volatile media. In one embodiment, the computer readable medium is non-transitory. In various implementations, non-volatile media includes optical or magnetic disks, such as disk drive component 310, and volatile media includes dynamic memory, such as system memory component 306. In one aspect, data and information related to execution instructions may be transmitted to computer system 300 via a transmission media, such as in the form of electrons, acoustic or light waves, including those generated during radio wave and infrared data communications. In various implementations, transmission media may include coaxial cables, copper wire, and fiber optics, including wires that comprise bus 302.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 330 (e.g., network 160 of FIG. 1, such as a LAN, WLAN, PTSN, and/or various other wired or wireless networks, including telecommunications, mobile, and cellular phone networks) may perform instruction sequences to practice the present disclosure in coordination with one another.

Computer system 300 may transmit and receive messages, data, information and instructions, including one or more programs (i.e., application code) through communication link 330 and communication interface 312. Received program code may be executed by processor 304 as received and/or stored in disk drive component 310 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A method for facilitating electronic commerce over a network, the method comprising:
creating a user profile comprising information including data entered by a primary user related to a product or service on a user device as well as data from other users that are related to or have common interests with the primary user, wherein the user profile dynamically changes based on, at least in part, new actions by the primary user as well as new actions by the other users;
weighing the information in the user profile to determine targeted recommendations for the primary user; and
providing the targeted recommendations to the primary user based on the user profile.

2. The method of claim 1, further comprising delivering relevant notifications to the primary user about desired products or services, wherein the delivering further comprises delivering deals or finds on the desired products or services directly to the user device and allowing the primary user to either purchase the desired products or services using a payment provider, explore auctions, or tell the other users about the deals.

3. The method of claim 1, further comprising allowing the primary user to enter search information for the product or service on the user device via a standard search, via a product code search or via a like or vague item search.

4. The method of claim 3, further comprising:
if there is a deal available for the product or service upon entering of the search information, delivering the deal for the product or service to the primary user on the user device;
if there is no deal available for the product or service upon entering of the search information, allowing the primary user to save the search information for the product or service, and alerting the primary user as soon as a deal comes available.

5. The method of claim 4, further comprising allowing the primary user to share with the other users when a deal is available, wherein the allowing the primary user to share further comprises allowing the user to post and receive messages, via the user device, to the other users by sending a message directly to one of the other users, or posting to an associated website or social media.

6. The method of claim 1, wherein the user profile comprises at least one of user search information, user purchases, user-entered data, user past preferences, or purchases and searches from the other users.

7. The method of claim 1, wherein the creating the user profile that is dynamically changing further comprises continually changing the user profile with the new actions by the other users, wherein the information in the user profile is weighted based on how closely aligned another one of the other users is with the primary user.

8. The method of claim 1, further comprising allowing the primary user to see information on products or services that the other users have found.

9. The method of claim 1, wherein the weighing further comprises determining a score for a new product or service based on attributes of the new product or service compared to data in the user profile and filtering the score against a threshold, wherein the providing of the targeted recommendations to the primary user is made if the threshold is met.

10. The method of claim 1, further comprising matching one or more like-minded twin users having similar preferences as the primary user, and sharing recommendations between the primary user and the one or more twin users.

11. A system comprising:
a client device interacting with at least one or more processors over a network; and
one or more memories adapted to store a plurality of machine-readable instructions which when executed by the one or more processors are adapted to cause the system to:
load an application on the client device wherein a primary user of the client device is allowed to enter data related to a product or service using the client device;
create a user profile comprising information including the data entered by the primary user as well as information from other users that are related to or have common interests with the primary user, wherein the user profile dynamically changes based on, at least in part, new actions by the primary user as well as new actions by the other users;
weigh the information in the user profile to determine targeted recommendations for the primary user; and
provide the targeted recommendations to the primary user based on the weighted information of the user profile.

12. The system of claim 11, wherein the plurality of machine-readable instructions are further adapted to cause the system to retrieve information to find relevant search results contributing to one or more keywords.

13. The system of claim 11, wherein the plurality of machine-readable instructions are further adapted to cause the system to parse data received from at least one data stream that identifies new products or services, and changes to products or services, and extracts relevant keywords.

14. The system of claim 13, wherein the plurality of machine-readable instructions are further adapted to cause the system to take the extracted relevant keywords and apply them as attributes against a particular product or service, and compare the particular product or service attributes against attributes stored in the user profile to determine how closely the particular product or service matches interests of the primary user.

15. The system of claim 14, wherein the plurality of machine-readable instructions are further adapted to cause the system to weigh the attributes stored in the user profile, and sum all the attributes to determine a score for the primary user, and if there are no attributes stored in the user profile, derive an initial value of an attribute by summing an attribute weighting from the other users.

16. The system of claim 15, wherein the plurality of machine-readable instructions are further adapted to cause the system to compare the score with a threshold to determine if the particular product or service is to be recommended to the primary user now or later.

17. The system of claim 13, wherein the plurality of machine-readable instructions are further adapted to cause the system to keep each product or service through a lifecycle managed by a state machine.

18. A system comprising:
a user device having an application downloaded therein that allows a primary user to enter information related to products or services;
at least one storage device that stores a user profile comprising the information entered by the primary user, and community user information of other users, wherein the other users have an affinity with the primary user based on comparisons of distance or attribute preferences between the primary user and the other users;
at least one processor that interacts with the user device and the at least one storage device, wherein the at least one processor executes a plurality of machine-readable instructions adapted to cause the system to:
create the user profile comprising information including the information entered by the primary user as well as information from the other users based on their affinity with the primary user, wherein the user profile dynamically changes based on, at least in part, new actions by the primary user as well as new actions by the other users;
weigh the information in the user profile to determine targeted recommendations for the primary user; and
provide the targeted recommendations to the primary user based on the user profile.

19. The system of claim 18, further comprising a webscraper that retrieves information to find relevant search results contributing to one or more keywords, wherein the information retrieved by the webscraper is supplemented with user personal information.

20. The system of claim 18, further comprising a parser that parses data received from at least one data stream that identifies new products or services, and changes to products or services, and extracts relevant keywords.

21. The system of claim 20, further comprising a keyword matcher and a keyword manager that take the extracted relevant keywords from the parser and apply them as attributes against a particular product or service.

22. The system of claim 21, wherein the at least one processor executes a plurality of machine-readable instructions further adapted to cause the system to compare the particular product or service attributes against attributes in the user profile stored in the storage device to determine how closely the particular product or service matches interests of the primary user.

23. The system of claim 22, wherein the at least one processor executes a plurality of machine-readable instructions further adapted to cause the system to weigh the user profile attributes, and uses a sum of all the attributes to determine a score for the primary user, and if there are not user profile attributes, an initial value of an attribute is derived by summing an attribute weighting from the other users based on the affinity between the primary user and the other users.

24. The system of claim 23, wherein the at least one processor executes a plurality of machine-readable instructions further adapted to cause the system to compare the score with a threshold to determine if the particular product or service is to be presented to the primary user now or later.

25. The system of claim 21, wherein the application further allows the primary user to provide feedback on the particular product or service, wherein the feedback is recorded for the particular product or service and applied to associated attributes, wherein the at least one processor executes a plurality of machine-readable instructions adapted to cause the system to analyze the feedback to determine a user's relative value per attribute.
